(19) United States
(12) Patent Application Publication
(10) Pub. No.: US 2006/0080146 A1
(43) Pub. Date: Apr. 13, 2006

(54) Method to improve the quality and cost effectiveness of health care by directing patients to healthcare providers who are using health information systems

(76) Inventors: Roger Harvey Cook, Los Alamos, NM (US); Olha Pavlivna Molchanova, Los Alamos, NM (US)

Correspondence Address: Roger Cook, 119 Grand Canyon Drive, Los Alamos, NM, 87544, US

(21) Appl. No.: 11/232,709

(22) Filed: Sep. 22, 2005

Related U.S. Application Data
(60) Provisional application No. 60/613,272, filed on Sep. 27, 2004.
(60) Provisional application No. 60/641,114, filed on Dec. 31, 2004.

(51) Int. Cl. G06Q 10/00

(52) U.S. Cl. 705/2

(57) ABSTRACT

Method to identify health information systems based on compatibility and capability of improving quality, safety and cost effectiveness of health care, to identify healthcare providers who are using such technology and to assist patients to find these healthcare providers. Provides the unexpected benefits of accelerating the adoption of health information technology by all healthcare providers and hastening the evolution of that technology.

### BACKGROUND OF THE INVENTION

1. The Field of the Invention

The improvement of healthcare quality, safety and cost effectiveness and systems by which to obtain these results; specifically, assisting patients to find healthcare providers who are using health information systems.

2. Prior Art

The terminology used in the prior art is inconsistent. Various terms are used, sometimes loosely and interchangeably. Commonly used terms include electronic health record (EHR) systems, electronic medical record (EMR) systems, electronic patient health record systems, computerized health record systems, computerized patient record (CPR) systems (CPRS), personal health record (PHR) systems, health information systems (HIS) and health information technology (HIT). The last of these terms (HIT) can be considered to encompass all the others.

We will be consistent throughout this application (except in the title, the abstract and in quoting other sources where the terms used in the original document will be used) in using the terms electronic medical record or EMR because we believe that this invention's ability to accelerate the adoption and evolution of EMR's is its greatest value. We will use these terms to make this value more clear however we intend that the term electronic medical record or EMR be interpreted to include EHR's specifically and all health information technology in general.

The term “referral” will be used to mean any form of communication intended to assist a patient in finding a healthcare provider and may include educating the patient about the reasons for making certain healthcare provider choices as well as providing the patient with the information required to make such choices.

The phrase “temporally proximate” will be used to describe referrals which take place at the time the patient is actively searching for a healthcare provider or very soon before the patient starts to search for a healthcare provider.

Telephone books, insurance companies, hospitals, healthcare provider groups and other organizations assist patients to choose a healthcare provider based on location and limited additional information such as the general field of specialization of that healthcare provider. They do not assist a patient to find a healthcare provider who offers the advantages of an EMR.

Some resources such as the on-line systems of medical specialty organizations provide referrals of patients to healthcare providers certified in that medical specialty. They do not assist a patient to find a healthcare provider who is using an EMR.

Some special interest groups such as “The American Lyme Disease Foundation” provide referrals for patients to healthcare providers with special skills in particular fields. Again they do not assist a patient to find a healthcare provider who is using an EMR.

U.S. Pat. No. 5,764,923 provides a method by which patients are “guided to an appropriate level and type of care for their problem(s) based on their level of risk and set of potential needs” as determined by “a plurality of branched chain logic algorithms which assess the patient's level of medical risk”. While this is a “referral system” it addresses a completely different need based on the assessment of medical risk. It also does not assist a patient to find a healthcare provider who is using an EMR.

U.S. Pat. No. 5,471,382 also implements a healthcare referral system and again it does so by assessing the patient's level of medical risk and determining appropriate timing, type, and level of medical care. Once again it addresses a different need based on medical risk and does not assist a patient to find a healthcare provider who is using an EMR.

U.S. Pat. No. 6,697,783 claims to “efficiently provide medical, pharmaceutical, and health benefit advice and information for an enrolled population” including physician referrals. First, this system relates to an “enrolled population” on which the system already has a “member profile” for the patient. Second, this system does not assist a patient to find a healthcare provider who is using an EMR.

U.S. Pat. No. 6,014,629 implements a healthcare provider referral system “for printing a group physician directory” based on physician specialty and customer address. This patent relates to the referral of patients to physicians within a subgroup of physicians such as those that are on a particular insurance panel. It does not relate to assisting patients to find healthcare providers who are using an EMR.

Some websites such as http://health-care-it.advanceweb.com and http://www.healthcare-informatics.com present assessments of the technological sophistication of current EMR's. They are aimed at healthcare professionals and health information executives as is made clear from the name of the first website “ADVANCE for Health Information Executives” and the “About Us” from the second website which states: “Healthcare Informatics is a monthly business magazine that provides timely, high-quality intelligence about information technology for the executives and managers on the IT decision-making team in healthcare facilities and organizations of every type.” Such websites are not aimed at patients and are not patient-friendly. Although there is some superficial resemblance to part of our invention they are designed to accomplish a purpose which is completely different. A patient could use them to learn about individual EMR systems but they do not assist patients to find healthcare providers who are using an EMR.

In the Jul. 23, 2004 report of the NATIONAL COMMITTEE ON VITAL AND HEALTH STATISTICS—NATIONAL HEALTH INFORMATION INFRASTRUCTURE WORK GROUP—2004 CORNERSTONES FOR ELECTRONIC HEALTH CARE (http://www.ncvhs.hhs.gov/040723tr.htm#incentives) Susan Christiansen reported: “create a consumer and provider education campaign on the benefits of EHR adoption, and also create a public reporting system to highlight physicians who have adopted and are using EHRs for consumers who want to use them. Establish a certification process for EHRs that clinicians can use when purchasing.”

This proposal will be examined one section at a time:
i) “create a consumer and provider education campaign on the benefits of EHR adoption”. This proposal does not indicate how consumers should be educated. It does not describe any method or timing of such education so as to optimize the impact on patients' selection of healthcare providers. Such non-targeted education would be expensive and less efficacious in influencing patient behavior compared to appropriately targeted education.
ii) “create a public reporting system to highlight physicians who have adopted and are using EHRs for consumers who want to use them”. This proposal would give highly motivated consumers the opportunity to find healthcare providers with EMR's but the majority of consumers would be unlikely to take advantage of such an opportunity because they would be unlikely to think about it at the time when they are searching for a healthcare provider. In the preferred implementation of our invention, patients who are actively in search of a healthcare provider are educated about the value of EMR's while they are searching for a provider and then immediately presented with an easy way to search for providers with EMR's. This will have a much greater impact on patient behavior than a system in which the education and search opportunity are not targeted to the moment of decision making. This proposal also fails to take advantage of the presentation of EMR assessment results to patients as will be described in the following paragraph.
iii) “Establish a certification process for EHRs that clinicians can use when purchasing.” Certification fails to take advantage of graded assessment of EMR's with the result that an EMR that barely gets certified will be “certified” the same as the most advanced EMR systems. This proposal also fails to take advantage of the presentation of EMR assessment results to patients. In our invention the combination of graded assessment and presentation of the graded assessment results to patients will result in pressure on healthcare providers to obtain an advanced EHR and to upgrade the technology over time so as to remain competitive. It will also result in more pressure on EMR makers to compete with one another because healthcare providers will be considering more than just “certified” or “not certified” in choosing an EMR system.

By combining these ideas our invention will not only hasten the adoption of EMR systems, it will also accelerate the evolution of EMR systems.

A website http://www.medem.com/ provides secure email communication between healthcare providers and their patients. It claims to provide “Access to new, insured patients through links from health plan online provider directories (more than 55 million covered lives) directly to your Medem practice Web site.” This service addresses a different problem because it does not assist patients to find providers who are using EMR systems.

Many EMR vendor websites provide information about healthcare providers that are using their EMR products. There is no search engine and they do not help a patient find a provider with EMR's in general nor do they objectively grade EMR's by the performance of the systems. The information is not aimed at patients but rather for the promotion of their own products to healthcare providers. Many vendor websites actually refer to this information as “testimonials”.

Several health insurance companies have implemented “pay-for-performance” systems in which healthcare providers receive a positive or sometimes negative “reward” based on measures of their performance. The performance measures may be cost-of-care or such things as obtaining appropriate laboratory tests at appropriate intervals for patients with certain chronic diseases. The rewards are usually financial but also can be in the form of differential access to patients. In one implementation of the differential patient access approach, the patient, while looking at a healthcare provider directory sees “stars” beside the names of certain providers. These stars are supposed to indicate providers whose care is in some way better. This implementation was been widely criticized because of its use of performance data that was outdated. In many cases small sample size made the data of dubious statistical validity. An excellent provider for whom a certain insurance company represents a small part of his work will have a small sample size. As result he will be denied a “star” rating and patients will be directed away from him. Providers who have been in practice for less than a few years might not have any performance data. Such providers are therefore also denied “stars” making it more difficult for them to build their practices.

An influential November 2004 report by American Healthways on “Pay-for-Performance” systems (http://www.rewardingquality.com/resources/Outcomes_final.pdf) stresses “transparency” as a design principle and states: “Two design principles can be derived from the concept of transparency. The first relates to making the method used to pay physicians or groups transparent to the public.” Recent pay-for-performance systems have failed to meet this design principle of transparency.

Several websites including http://www.bestdoctors.com/en/about/wrong.htm and http://www.castleconnolly.com/ offer a service in which they refer patients to the “best doctors” usually based on information such as the provider's popularity with other healthcare providers. Some others base the referral on popularity of providers with patients. There is no evidence for the assumption that such systems assist a patient to find higher quality healthcare.

The primary purpose of our patent is to improve the healthcare of all Americans. An Internet service called “Bridges to Excellence” offers a system called “Physician Office Link” (POL) which is intended to achieve the same purpose.

The POL system involves “recognizing” certain physicians who meet “established performance standards”. The POL assessment tool has a maximum score of 900 points of which only 190 (21%) require use of a computer (and fewer still require an EMR). In addition, obtaining a passing score does not require the use of a computer at all. Therefore, while EMR use is part of the POL assessment system, POL cannot be viewed as a system for referring patients to providers who are using EMR's.

The idea of “moment of decision referral” is not new. POL probably uses this by highlighting POL recognized physicians in “provider directories” (if by this they mean health plan provider directories). However POL does not use the combination of “moment of decision referral” with referral to providers who are using EMR's.

The POL program publicly reports on the POL and NCQA websites those physicians who have been “recognized”. Using this system a patient can determine if a given provider is “recognized” or not. The report is not graduated so all healthcare providers are lumped into two groups: “recognized” and “all others”. The later group includes those who failed to meet the standard as well as all those that have never applied. Providers who are unable or unwilling to make enough changes to gain POL recognition or who are unwilling to deal with all the paperwork involved in the POL system can still make important improvements in their care. By failing to provide graduated assessment reports to patients the POL program gives these providers no recognition or incentive to obtain EMR systems.

The business model of POL uses a system of rewarding “recognized” physicians in office practices “up to $20,000 annually and up to $50,000” total over the three year life of the initiative. The rewards are paid by health insurance companies and employers. The cost of health insurance is already a heavy burden for many small employers. It is unlikely that the promise of long term savings will convince them to pay more to use the POL program.

Nearly 45 million Americans, disproportionately represented by minorities and children, do not have health insurance at all. The uninsured will be unable to benefit from the POL system and, as explained below they may actually be harmed by it.

POL charges insurance companies and employers a licensing fee after which they are obliged to pay each POL recognized provider up to $20,000.00 in the first year. This is an enormous expense for the insurance companies and employers.

Because employers and health insurance companies are in direct communication with patients just prior to and during the patient's process of selecting a healthcare provider they are the ones who will choose what service to use to help patients find the best healthcare. There is little incentive for employers and health insurance companies to use the POL system when a competing service, using a different approach, can improve healthcare by accelerating the adoption of EMR's and do this more effectively and at little or no cost to employers and health insurance companies.

The POL license denies health insurance companies the freedom to design their own system to reward healthcare providers for being recognized by POL. In particular, the health insurance company is prevented from using a pay-for-performance system in which the performance measure is POL recognition and the “pay” component is not financial but improved patient access (access-for-performance). Depending on the insurance company and the market in which it operates, an access-for-performance system may be much more desirable to the insurance company and employer.

The above problems with the POL system relate directly to the claims in our patent application. The following describes other problems with POL.

Limited provider involvement:
To be eligible for the POL rewards system a provider must: 1) be an MD or DO (midlevel providers are excluded), 2) be a primary care physician, endocrinologist, cardiologist, or neurologist. (all other specialties are excluded), 3) provide care to eligible patients identified by “Bridges to Excellence”, based on data supplied by participating health plans for participating purchasers (ie the patient's health plan or employer must be offering the money). Only a minority of healthcare providers meet all these requirements, therefore the benefits that POL can achieve in terms of improving healthcare are limited by this lack of universality.
To become recognized by POL, a provider must pay $100.00 for a survey tool which he uses to determine if he might be eligible. Next there is a $450.00 application fee. These costs are insignificant compared to the hours of administrative time required to gather the data to complete the application. “Bridges to Excellence” does not state an administrative time estimate for the POL program but for their similar Diabetes Care Link (DCL) program their estimate is: “applicants should anticipate that it will require 1-3 months to identify eligible patients, abstract data for these patients from medical records and/or administrative systems, enter data into the self-assessment worksheet and submit all completed materials and their application to NCQA.”
The direct and indirect cost of obtaining POL recognition is so high that only physicians with a substantial number of eligible patients will find the program worth their trouble. Providers who go through this process and are denied “recognition” lose all of their investment.

Incentives only apply to a select group of providers:
Healthcare providers who are unlikely to meet the high standards required for recognition by POL have no incentive at all to obtain an EMR system.
The POL program also fails to take advantage of the opportunity to create competition among high performing healthcare providers who are already recognized by POL. High performing providers therefore are not given any incentive to keep their EMR systems up to date with the most advanced tools. This in turn results in the failure of POL to put pressure on the makers of EMR systems to produce better systems over time.

Benefits apply only to a select group of patients:
Because POL reports certification instead of graduated reports it fails to provide the great majority of patients with a tool to help them choose from among the providers who are not POL recognized.

Harm to patients who are not enrolled in a POL program:
If the POL program is successful then the “recognized” providers will be busy seeing POL participating patients. The financial incentives will encourage them to exclude non-participating patients. Non-participating patients will be forced to find a provider who is not POL recognized. If POL recognition really does identify the best healthcare providers then the result will be that employees of large companies that can afford POL will get the best care. Employees of small companies, the uninsured and the underinsured (which are over-represented by minorities) will have to choose from the providers that are left over.
Real success for POL means that a large percentage of physicians will improve their care and obtain POL recognition. In most ways this is quite desirable but the way in which POL accomplishes its goal has the unexpected disadvantage of achieving its benefits at the expense of causing harm to the uninsured and underinsured. This occurs as follows:
At present the underprivileged in our society receive healthcare from providers who range from the best to the worst. There is no doubt some tendency for them to receive lower quality care than average but this situation is not systematically forced on them.
The worst healthcare providers are the ones most likely to make mistakes therefore they are the ones whose care would benefit most from the use of an EMR. Those same healthcare providers have no expectation of obtaining POL “recognition” therefore POL gives them no incentive whatever to obtain EMR systems.
Healthcare providers recognized by POL are paid more for seeing POL participating patients. As long as there are enough POL participating patients to keep them busy they have no incentive to see non-participating patients.
Underprivileged patients will be systematically excluded from seeing POL recognized physicians because they are not POL participating patients. The underprivileged will be systematically forced to obtain their healthcare from the worst providers, a worse situation than these patients are in currently. Worse still, the POL system provides no tool to help these patients choose the best provider who is realistically available to them nor does it provide any incentive for the worst healthcare providers to obtain EMR's.
The result is that POL widens gaps in the healthcare system by both worsening the situation for the poor and improving it for the rest of society. This system does not just leave the poor behind, it pushes them further down while large companies benefit financially from the system.

Other
While many patients will choose a provider based only on their own best interest some may consider other factors such as the providers use of a system that 1) communicates de-identified data with government authorities for public health purposes and for the early detection of bioterrorism, and 2) helps the provider identify patients who are candidates for clinical trials thereby enhancing medical research. The POL system will not help patients make these unselfish choices.

In summary, the POL program provides real benefits to a select group of physicians and patients at the expense of potential harm to disadvantaged patients. It does not provide “moment of decision referral” of patients to providers who are using EMR's. The lack of graded reporting to patients means that POL offers nothing to patients who can't see a POL recognized provider. Although POL does have some effect of accelerating the adoption of EMR's by healthcare providers it is inefficient because provider use of an EMR represents a small fraction of the POL performance measure. The stakeholders who have to pay the substantial cost of POL are the same ones who are in a position to choose a cheaper, more efficient system.

Until now, a patient trying to learn which healthcare providers use sophisticated, compatible EMR systems would have to research the various EMR systems available, determine which systems are suitable; contact the offices of the healthcare providers and request information on which, if any, system is in use by that healthcare provider. This is a cumbersome task which few patients would take the trouble to complete.

Objects and Advantages

Objects
i) To improve healthcare by educating patients about the need to consider use of an EMR in choosing a healthcare provider and preferably to provide this education at a time which will optimally influence the patient's selection of a healthcare provider.
ii) To provide a system by which patients can easily identify healthcare providers who offer healthcare which is enhanced by the use of EMR systems, preferably sophisticated, compatible EMR systems.
iii) Preferably to identify for the patient various levels of sophistication and compatibility of the EMR systems used by each health care provider.
iv) Preferably to provide the service in such a way that as few patients as possible are excluded from the benefits which the service provides.
v) Make the cost of the service low
vi) Make the service flexible

Advantages

Introduction:

EMR's are important tools in the healthcare industry. The term EMR and the other similar terms described at the beginning of the section on prior art can be misleading because they lump together the most primitive systems which do nothing to enhance the quality, safety and cost effectiveness of healthcare with sophisticated systems capable of significantly improving healthcare in terms of any or all of these measures.

It is difficult to overstate the value of these systems to healthcare. The following three observations are from the website of the US Department of Health & Human Services describing the “The Promise of Health Information Technology”:
1. “Quality Care: Quality of care could be substantially improved. Medical errors and medically-caused injuries and death, which can be caused by information-related factors ranging from inadequate record availability to poor handwriting, could be dramatically reduced. The Institute of Medicine has estimated that 45,000 to 98,000 deaths occur each year due to medical errors. [An Aug. 9, 2004 report by HealthGrades puts the number of such deaths at 195,000 per year.]
2. Decision Support: Quality of care could also be improved by providing timely and appropriate treatment information to health care professionals. With the explosion of knowledge and treatment options in health care, the Rand Corporation found that Americans get recommended care only 55 percent of the time. New technologies can feed a wealth of up-to-date treatment information directly to physicians and others as they care for patients.
3. Cost Effective Care: Savings in the range of $140 billion per year, close to 10 percent of total U.S. health spending, could be achieved through health information technology—by reducing duplicative care, lowering health care administration costs, and avoiding errors in care.”

Many EMR systems are incompatible with one another. More than one healthcare provider is often involved in the care of one patient. In the near future this situation will compromise patient care because of the inability of different healthcare providers to share the patient's health data.

Intended Advantages:
(1) Provides a means by which an individual can conveniently locate healthcare providers who offer care enhanced through the use of an EMR system.
(2) Provides a means by which an individual can distinguish varying degrees of sophistication of EMR systems (used by healthcare providers) ranging from primitive systems which do not have the potential to improve healthcare to those which can most optimally improve quality, safety and cost effectiveness of healthcare.
(3) Through the cooperation of health insurance companies and/or employers provides patients with education about the value of choosing a provider who is using an EMR and referral to a system which enables the patient to locate such providers. This education and referral can be most effective if it is temporally proximate to the moment the patient is searching for a new provider. Insurance companies can provide referrals when the patient is viewing the insurance company's eligible provider list. Employers can provide referrals when the patient selects a health insurance plan. Temporally proximate referral will increase the probability of influencing the patient's choice of healthcare provider because it catches the patient at or near the “moment of decision”.
(4) Maximizes the impact on healthcare by making the service available and useful to all patients without regard to their health insurance or employer.
(5) By making the service either free or very inexpensive for health insurance companies and employers this invention maximizes the chances that they will take advantage of temporally proximate referral to involve the largest possible number of patients.
(6) By making the service flexible health insurance companies and employers can either pay nothing for the service or they can reimburse healthcare providers for part, all or more than the cost of provider participation. The result is that the service can adapt to different insurance company and employer priorities and to different market conditions.
(7) This invention provides for a service which costs much less to operate than the “Bridges to Excellence” POL program. In our preferred embodiment the service is free to patients, employers and health insurance companies. Healthcare providers pay for the service but the cost is a fraction of the cost of applying for recognition in the POL program. Also consider that some providers will be denied recognition by POL and will lose their fees. The result is that our service is likely to be used by many more providers thereby giving patients more selection.
(8) This invention results in a service which places minimal administrative burden on healthcare providers—approximately 15 minutes compared to “1-3 months” of data collection and completing assessment tools for the POL system.
(9) Since this invention uses graded qualities of provider's EMR systems instead of a pass/fail system no provider will spend time and money only to be rejected.
(10) Our invention results in a competitive advantage for healthcare providers who are using EMR's. The competitive advantage can also be graded depending on measures of the quality of the EMR system in use. Our system adheres to the design principle of public transparency. The data for performance measures used in our invention come directly from healthcare providers and vendors of EMR systems both of whom benefit from keeping the data complete and current. With our invention, an individual healthcare provider is not unfairly disadvantaged by the variables of length of time in practice or small performance sample size.

vii) Unexpected Advantages:
(1) By empowering the patient in his choice of a healthcare provider this invention applies pressure on all healthcare providers to obtain and maintain up-to-date EMR systems. This benefits the healthcare of all patients regardless of whether they use the service that this system provides or not.
(2) Creates an incentive for the makers of EMR systems to make their products compatible with industry standards and one another.
(3) When important new ideas in EMR systems appear those same ideas that make them better are likely to make them less compatible or even incompatible with older systems. This invention shows patients and healthcare providers the technology advantages so that they can be balanced against the compatibility disadvantages.
(4) Accelerates the adoption of EMR's. This is so important that President Bush made an executive order in an effort to achieve this goal. By applying pressure on the healthcare provider to obtain an up-to-date EMR system this invention will accelerate the adoption of such technology resulting in cost savings estimated by the US Department of Health & Human Services at over $383,000,000.00 per day.
(5) Accelerating the adoption of EMR's will be of great financial benefit to health insurance companies and employers. They have a strong financial incentive to help patients find healthcare providers who are using this technology by educating patients about the value of choosing a provider with an EMR and directing them to the service which helps them find such providers.
(6) Simple advertising and education aimed at the public in general will have some effect of increasing the number of patients who choose a provider with an EMR system however referral of patients directly from insurance company websites to the provider referral service at the time they are choosing a provider will result in a higher probability that those patients will select a provider with an EMR. Healthcare providers, knowing that patients are being preferentially directed to providers with EMR systems (and in particular advanced EMR systems), will be effectively pressured to acquire and maintain an advanced EMR system in order to remain competitive.
(7) Presenting graded reports (as opposed to certified/non-certified) to consumers about the EMR system in use by each provider will result in providers having a powerful incentive to keep their technology up to date. This will, in turn, drive more competition among EMR makers thereby accelerating not just the adoption but also the evolution of EMR systems.
(8) All of the stakeholders involved in this system benefit:
   PATIENTS benefit in terms of healthcare quality, safety and cost effectiveness when they choose a healthcare provider who is using an EMR. This system costs patients nothing, therefore they experience a net benefit.
   PROVIDERS WHO ARE USING EMR'S benefit because the improved access to patients provided by this system is of much greater value than the expense of advertising. Therefore healthcare providers who are using EMR's will experience a net benefit from this system even if they do not receive any payments from health insurance companies or employers for participation in the system. If they do receive payments from health insurance companies or employers then the net benefit will be even more apparent.
   HEALTH INSURANCE COMPANIES AND EMPLOYERS benefit from this system because of the decreased cost of healthcare that results when patients choose healthcare providers who are using EMR's. Health insurance companies and employers potentially also experience the expense of whatever they choose to pay to healthcare providers as an incentive to use the system or as part of a pay-for-performance system. This system gives health insurance companies and employers the flexibility to optimize results by adjusting the amount (if any) that they pay to healthcare providers who are using EMR's given the prevailing market circumstances in their location and at that time.

The only stakeholder group that experiences a net loss with this system is the group of healthcare providers who are NOT using EMR's. This will encourage them to obtain EMR's which will then benefit patients, health insurance companies and employers.

### SUMMARY

EMR systems can significantly improve the quality, safety and cost effectiveness of healthcare. Most patients are not aware of the benefits that result from choosing a healthcare provider who is using any EMR system much less an advanced, compatible system. The prior art does not give patients any practical way to know which healthcare providers offer healthcare enhanced with this technology.

This invention enables the patient to choose a healthcare provider who uses an EMR system and optionally an advanced, compatible EMR system. It provides a means by which patients are educated and assisted in their decision making at the most effective time—the moment they are making the decision of what health care provider to choose. An unexpected benefit of this invention is the acceleration of the adoption of health information technology by all healthcare providers and the acceleration of the evolution of this technology. These effects will benefit all patients while reducing the cost of the healthcare system.

Administrative costs are already consuming much of the healthcare dollar. This invention accelerates the adoption of EMR's by healthcare providers while adding a much smaller financial burden than the service which represents the closest prior art. It also does so in a way which is useable to a much larger number of patients and healthcare providers. This invention does not have the effect of systematically forcing disadvantaged patients to the worst performing healthcare providers.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a diagram of an example system architecture for the improvement of the quality and cost effectiveness of healthcare by directing patients to healthcare providers who are using EMR systems according to one illustrative embodiment.

### DETAILED DESCRIPTION

EMR systems are evaluated based on their ability to share data with other EMR systems and the tools which are incorporated into the systems to enhance patient care.

### Preferred Embodiment

a) A database of EMR systems including data about the characteristics of each.

b) A database of healthcare providers including (among other data) the EMR system that each uses.

c) An internet website which provides users with a means to search for healthcare providers who use EMR systems based on location and optionally on other factors including medical specialty.

### Operation—Preferred Embodiment

a) Healthcare providers are charged a fee for being listed on the website.

b) EMR products are listed on the website for the benefit of healthcare providers who are researching EMR systems.

c) Health insurance companies and employers are not charged any fee for using the service.

d) Health insurance companies and employers will be given the option of reimbursing none, part, all or more than all of the cost for a healthcare provider to register on the website (giving these stakeholders a very flexible opportunity to encourage providers to register without imposing a fixed system on them).

e) EMR systems are graded with a graduated score.

f) Details of the performance measures of the EMR systems are made available to patients and healthcare providers.

g) The list of healthcare providers in the database can include any provider regardless of whether or not they are using an EMR system or the score of that system.

h) When reporting graduated scores of the EMR system in use by an individual provider, the grade is broken down as a score for compatibility with other EMR systems (“compatibility index”) and another reflecting how advanced the system is in terms of its ability to improve patient care and cost effectiveness of care (“technology index”).

i) Reports of compatibility of a provider's EMR are broken down into compatibility with the EMR systems of providers in the same geographic area (“local compatibility index”) and compatibility with the EMR systems of all providers across the country (“global compatibility index”).

j) Details of the data from which the technology and compatibility indices are derived are made readily available on the website to both patients and healthcare providers.

k) EMR vendors are provided with a list of the healthcare providers who have registered on the website claiming to be using their EMR product. Healthcare providers are also made aware that this will be done. EMR vendors can check these lists against their records of licensed clients and in return for receiving this data will be expected to notify our website if any false claims appear to have been made.

l) Advertising to the general public will be done but not emphasized as patients will be targeted at the moment they are choosing a healthcare provider through the health insurance companies and employers.

m) Health insurance companies and/or employers will promote this web service to healthcare providers as part of their “pay-for-performance” program emphasizing that registration at the website is required for the providers to obtain the patient access benefit of having an EMR system.

n) Insurance companies and employers will be involved in educating patients and referring them to the website where they can find providers using EMR's.

o) The website shows healthcare providers data on the compatibility of each EMR system with all the rest. This information is also used to generate the compatibility indices for patients. Giving healthcare providers this data results in a strong incentive for EMR system makers to determine and report compatibility because higher compatibility scores will make their product more attractive to prospective clients. They will also have more incentive to work with other EMR makers to make their products compatible with one another, thereby mutually enhancing their compatibility rating and hence their attractiveness to healthcare providers.

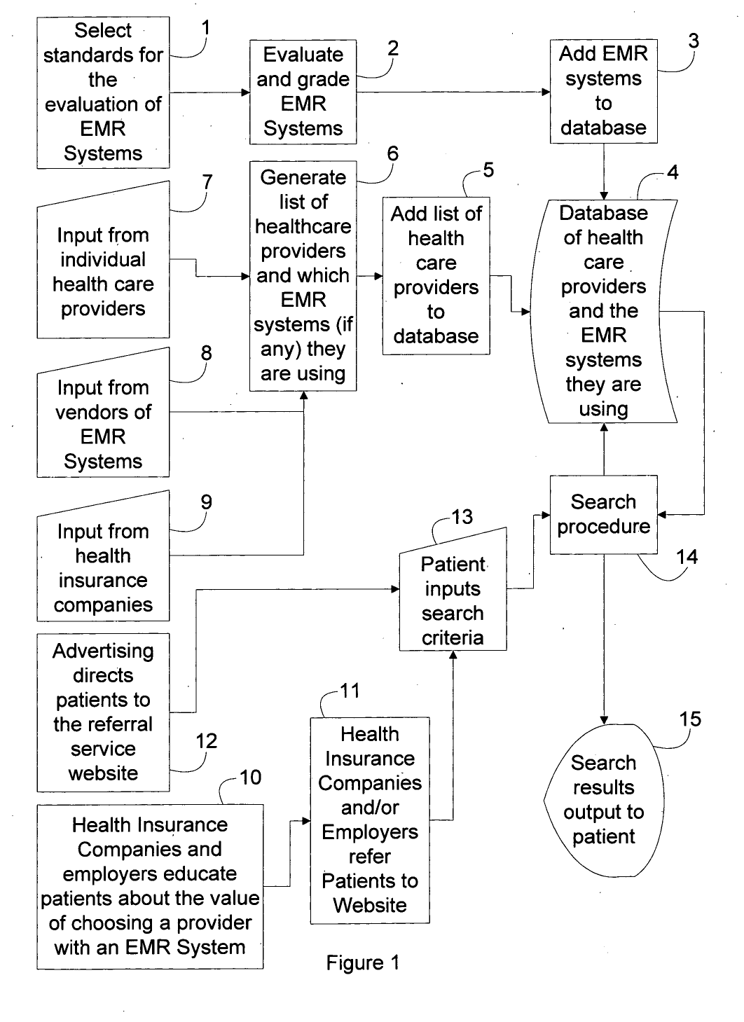

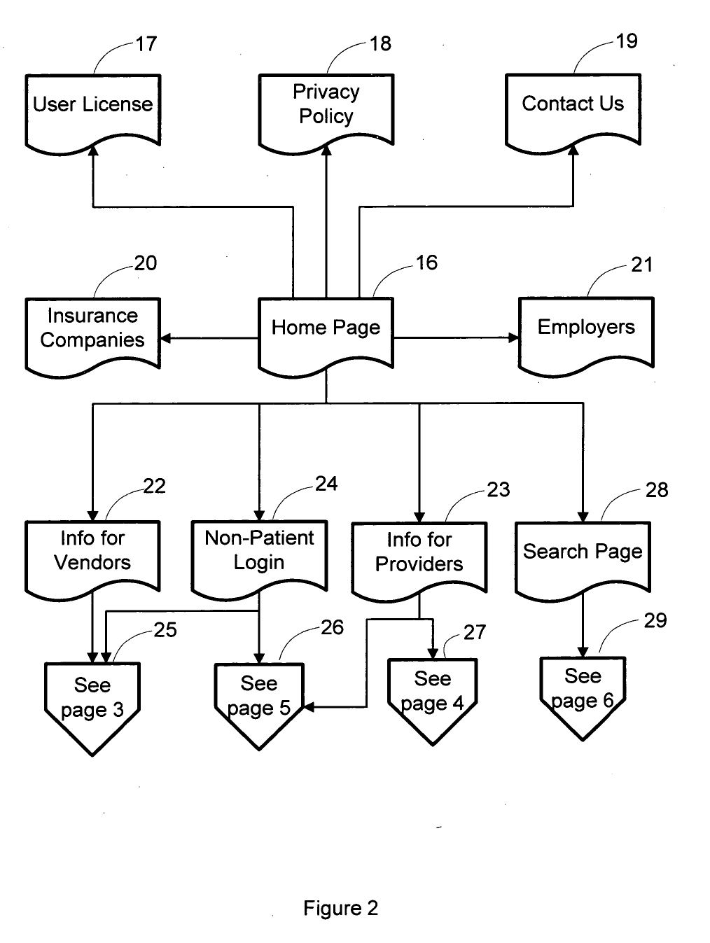

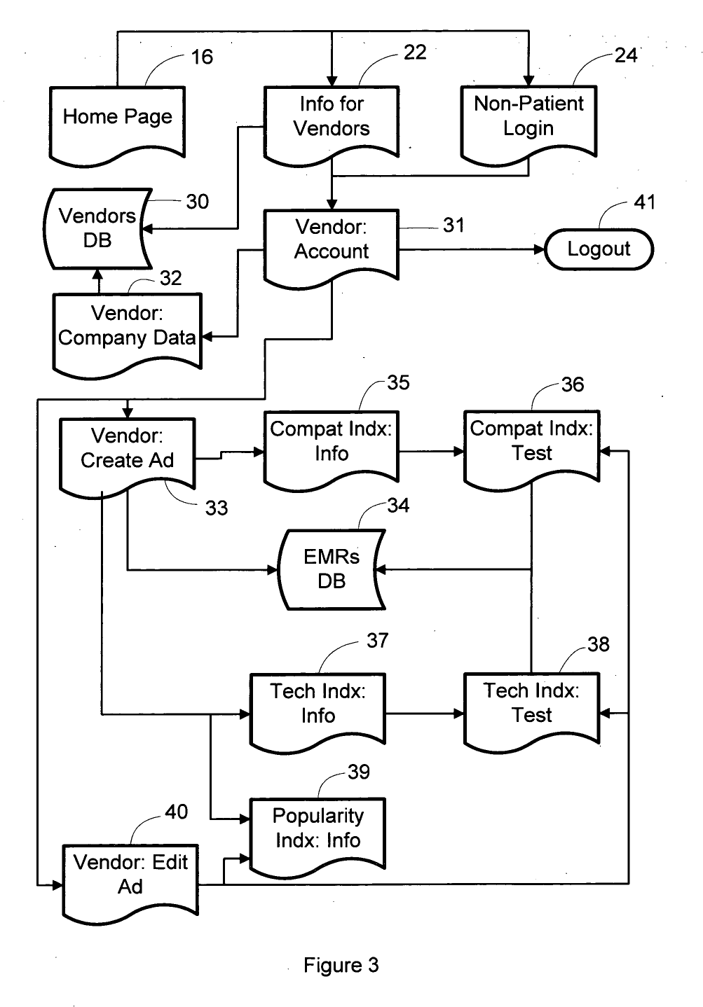

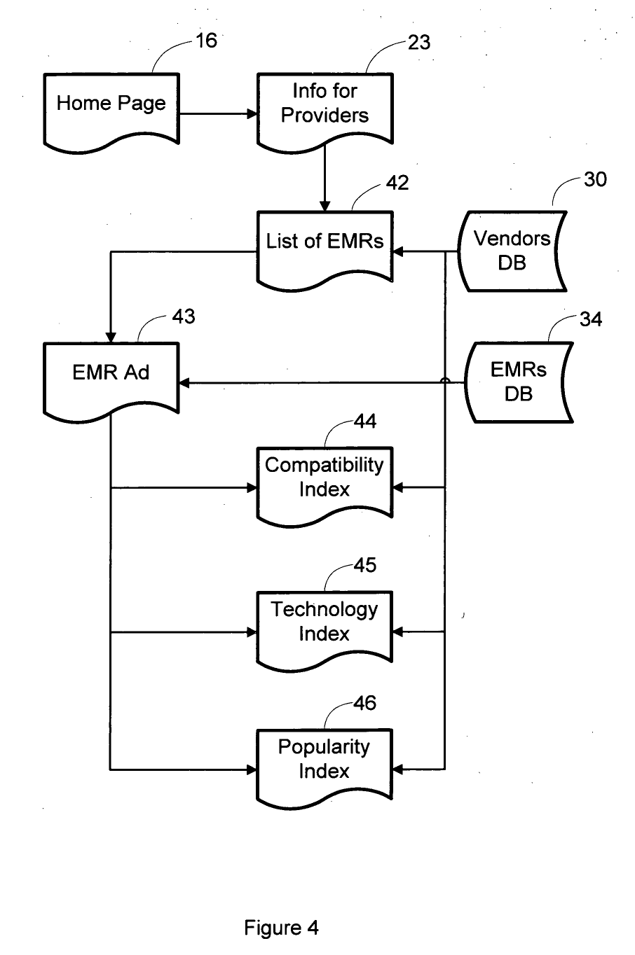

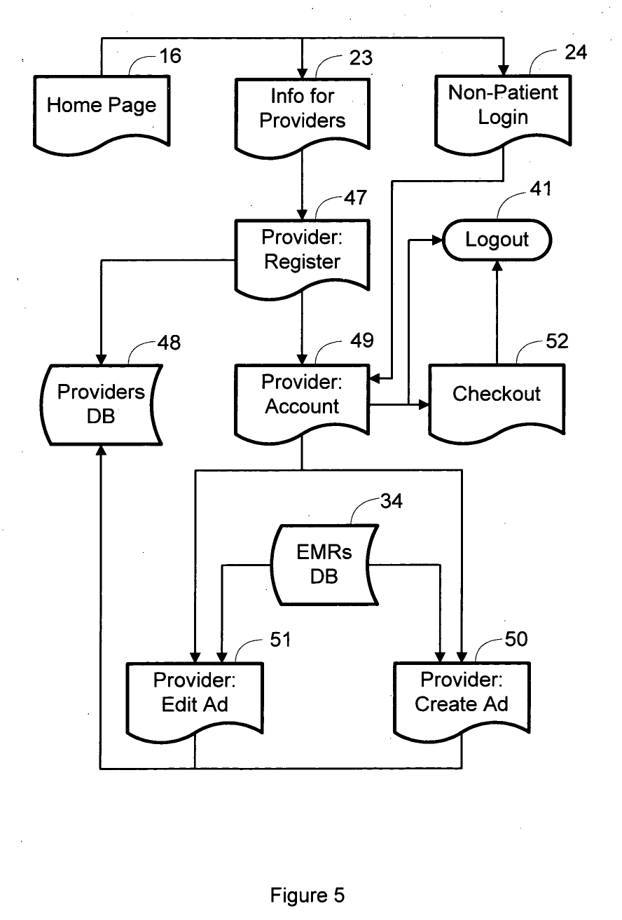

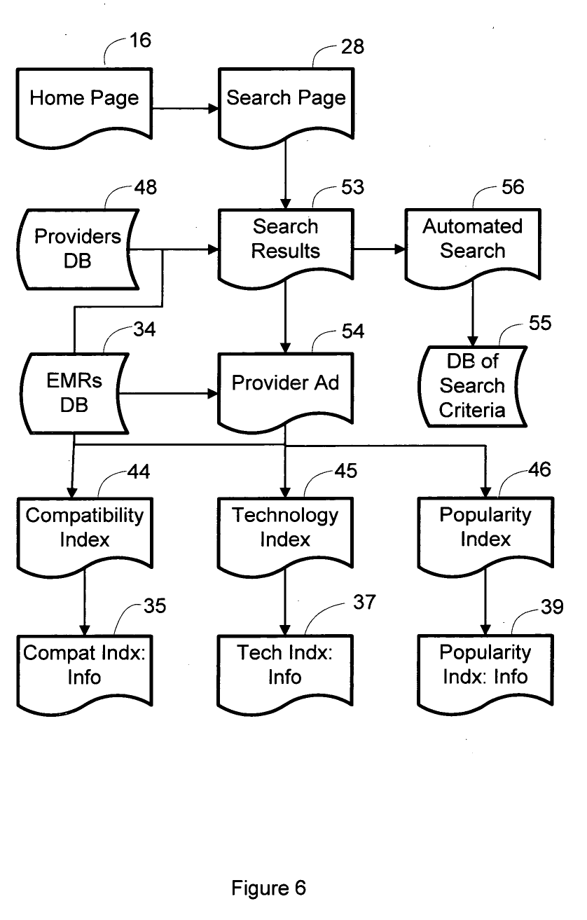

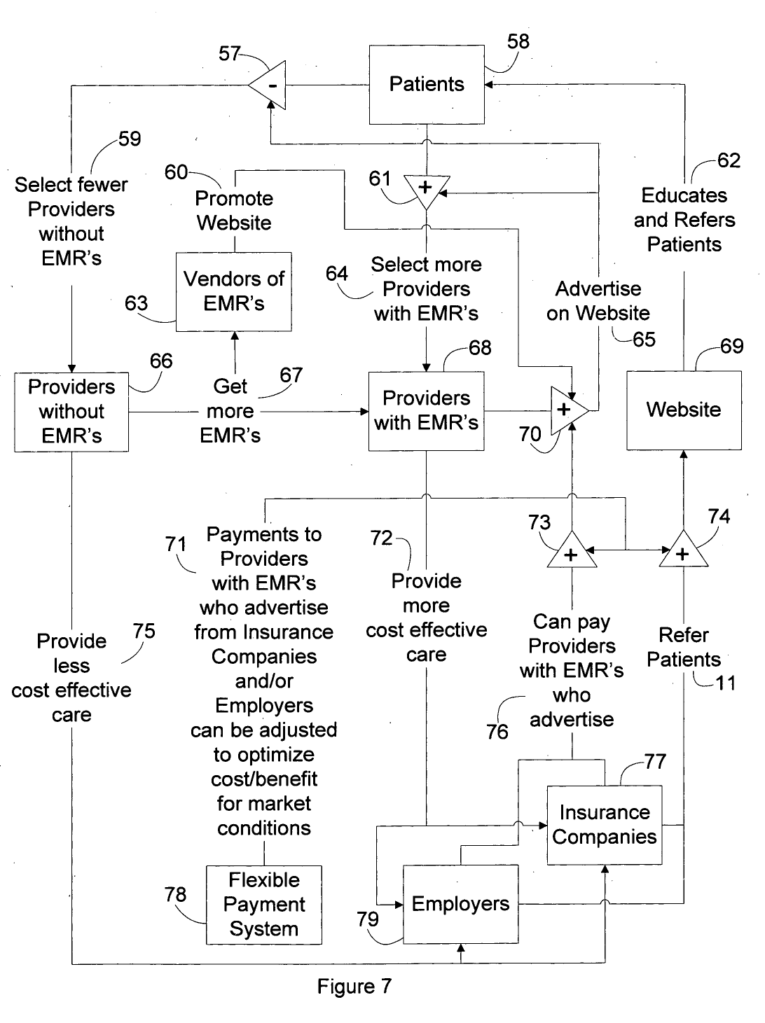

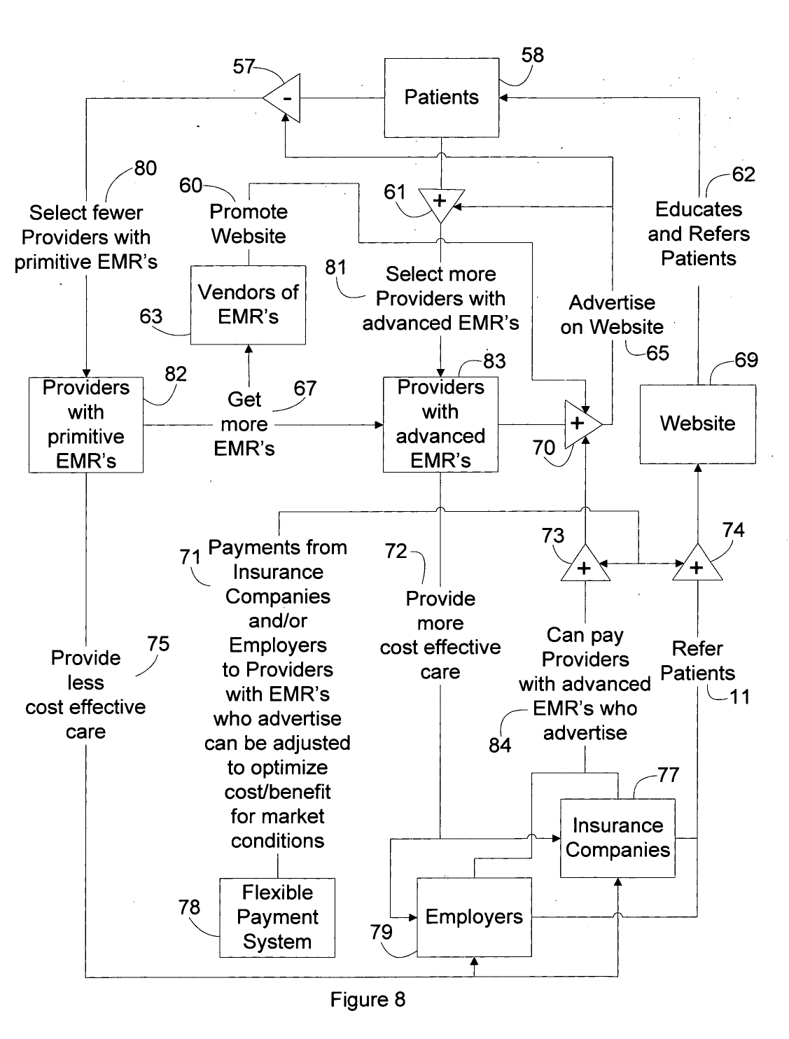

p) Numerical labels used below refer to numbers appearing in FIG. 1 on page 1 of the flow sheet drawing.

q) Standards are selected 1 by which to assess EMR systems for:
i) Compatibility with other EMR systems.
ii) Provision of clinical tools such as decision support systems that enhance patient care and control the cost of care by means such as eliminating duplication. The following are intended only as examples of questions that might be used to assess the clinical support systems built into EMR systems:
   1) DOES THE SYSTEM ALERT THE USER WHEN
      a) DRUGS:
         i) An order is entered for coumadin 50 mg. (Inappropriate drug dose)
         ii) An order is entered for cefprozil 500 mg in a 6 month old. (Inappropriate drug dose for age)
         iii) An order is entered for sertraline in a patient who is on pimozide. (Drug interaction)
         iv) An order is entered for amitriptylene in an 85 year old man. (Possibly inappropriate drug for the elderly)
         v) An order is entered for ciprofloxacin in a 5 year old. (Inappropriate drug for a child)
         vi) An order is entered for penicillin in a patient allergic to penicillin. (Allergy)
         vii) An order is entered for naproxen in a patient allergic to aspirin. (Possible allergic cross-sensitivity)
         viii) An order is entered for indomethacin in a patient with a history of a duodenal ulcer. (Inappropriate drug for past medical condition)
         ix) An order is entered for rosiglitazone in a patient with a diagnosis of congestive heart failure. (Inappropriate drug for current medical problem)
         x) An order is entered for metformin in a patient with elevated creatinine. (Inappropriate drug for lab value)
      b) INVESTIGATIONS:
         i) An order is entered for an X-ray with contrast material in a patient on metformin. (Need to stop drug before the test)
         ii) An order is entered for an X-ray with contrast material in a patient allergic to iodine. (Inappropriate investigative order)
         iii) An order is entered for an X-ray with contrast material in a patient with a diagnosis of renal insufficiency. (Warn due to disease-test interaction—risk of further kidney damage)
         iv) An order is entered for an X-ray with contrast material in a patient with an elevated creatinine. (Warn due to test-test interaction—risk of further kidney damage)
         v) An order is entered for a test which the patient had done recently. (Possible wasteful duplication)
      c) DRUG MONITORING:
         i) A patient on coumadin has not had an INR in more than 2 months. (Drug needs regular monitoring)
      d) DISEASE MONITORING:
         i) A diabetic patient has not had a HgbA1c test for more than 3 months (6 months if last HgbA1c was less than 6.5) (Disease needs regular monitoring)
      e) ADVERSE EFFECT MONITORING:
         i) A patient on lamotrigine presents with a rash. (Potentially serious side effect that is uncommon and may not be recognized)
         ii) A patient on carbamazepine develops leucopenia. (Potentially serious drug side effect appearing as a change in a lab result)
      f) MISSED OPPORTUNITIES:
         i) A patient with congestive heart failure is not on an ACE or ARB drug. (Standard of care)
      g) TRENDS:
         i) An elderly patient has lost more than 10% of his body weight. (Potential sign of serious illness that might not be noticed by the healthcare provider)
      h) HEALTH MAINTENANCE:
         i) A 40 year old patient whose last tetanus vaccine was 15 years ago. (Needs routine vaccine)
         ii) A 30 year old diabetic patient seen in November has not yet received flu vaccine. (Needs vaccine based on disease)
         iii) A 60 year old woman has not had a mammogram for 4 years. (Need routine test)
         iv) A 45 year old woman with ulcerative colitis last had a colonoscopy 12 years ago. (Needs test based on disease)
         v) A 38 year old woman whose mother had breast cancer. Patient has never had a mammogram. (Needs test based on family history)
      i) DIAGNOSTIC DECISION SUPPORT:
         i) A 30 year old man on Prozac presents with fever, sweating, anxiety, headache, diarrhea, nausea and tremor. (Provider needs to consider an uncommon diagnosis—serotonin syndrome.)
      j) RESEARCH:
         i) A patient with lung cancer is a candidate for a clinical research trial. (Matching of patients to suitable clinical trials)
   2) DOES THE SYSTEM PROVIDE ASSISTANCE ON DEMAND:
      a) DIAGNOSTIC DECISION SUPPORT:
         i) Can the system propose a differential diagnosis for a given cluster of symptoms?
      b) INVESTIGATIVE DECISION SUPPORT
         i) Can the system propose investigations for a given cluster of symptoms or working diagnosis?
      c) THERAPEUTIC DECISION SUPPORT
         i) Can the system provide “standard of care” advice for specific diseases?
         ii) Can the system provide the healthcare provider with information on the cost of proposed treatments?
         iii) Can the system propose therapeutic alternatives that might be less expensive?
         iv) Can the system propose therapeutic alternatives for a given patient based on his health insurance formulary?
      d) RESEARCH:
         i) Can the system provide details about an available clinical research trial?
   3) CAN THE SYSTEM EXCHANGE DATA WITH “PERSONAL HEALTH RECORD” SYSTEMS?
   4) CAN THE SYSTEM PRODUCE A “CONTINUITY OF CARE RECORD”?
   5) DOES THE SYSTEM SUPPORT PUBLIC HEALTH AND NATIONAL SECURITY?
      a) Does the system report suspicious trends in symptom clusters or diagnoses to public health authorities?
      b) Can the public health surveillance part of the system be updated frequently and automatically so as to be useful for early detection of bioterrorism?

r) EMR systems are evaluated and graded (FIG. 1) 2 against the standards.

s) The list of EMR systems is added 3 to the database 4.

t) Healthcare providers can input 7 their information into the system.

u) Optionally the makers of EMR systems can input 8 data on healthcare providers who use their systems.

v) Optionally insurance companies can input 9 data on healthcare providers credentialed for their plans.

w) A list of healthcare providers is then generated 6 and added 5 to the database 4.

x) The information collected about the healthcare provider includes some means of identifying location such as ZIP code and area(s) of specialized medical qualification. Without any effort to be exhaustive the list might also include:
1. Address.
2. Telephone number.
3. Degree in the case of individuals.
4. Area(s) of medical interest regardless of special qualification.
5. Board certification status in the case of individuals.
6. JCAHO accreditation status in the case of institutions.
7. Age range of patients seen.
8. Whether the healthcare provider is accepting new patients.
9. List of insurances accepted.
10. Type of facility in the case of institutions.

r) Most patients seeking healthcare, first obtain health insurance, usually through their employer. Employers present 10 educational material showing their employees why they should consider EMR's in choosing a healthcare provider.

s) After educating the patient as above, employers present their employees 11 with information directing them to the website of the referral service.

t) Having chosen a health insurance, patients usually have to choose a healthcare provider that is “covered” by that insurance. The patient does this by looking at the eligible “provider list” which the insurance company publishes on paper, online or both. The insurance company presents 10, in their provider list publication, educational material showing patients why they should consider EMR's in choosing a healthcare provider.

u) After educating the patient as above and while presenting the list of eligible providers, the health insurance company also presents 11 a hypertext link to the website of the referral service. In the case of printed material the web address of the referral service would be presented 11 along with the list of eligible providers.

v) The availability of the referral service is also made known to the general public by means such as advertising 12.

w) A website 13, 14 & 15 is provided at which a user can enter 13 a location such as a ZIP code and optionally one or more other items such as medical specialty, enabling the user to conveniently obtain 15 a list of appropriate healthcare providers who (or which) offer healthcare enhanced through the use of an EMR system. This list may include providers who do not use EMR systems but those that do will be listed first and the fact that they use an EMR system will be readily apparent. The details of the website are described further below.

x) Pharmaceutical companies might also be offered advertising space on the website with the option for the displayed advertisement to be selected based on the specifics of the user's search (eg medical specialty).

y) Description of the website:
Commercial websites are large projects that typically take more than a year to develop. At the time that this patent application is submitted the website that implements this invention has been 9 months in development but it is not yet complete. The incomplete website already exists as http://www.healthrefer.com. Because the code for the website, as it currently exists, is incomplete and has known “bugs” the website will be documented by means of flowcharts and description. Many pages of the current website as we have chosen to implement it are not necessary for the function of the service and so, for clarity, they have been left out of the flow charts and description.

FIGS. 2 through 6 describe a web-site which implements the “Method for the improvement of the quality and cost effectiveness of health care by directing patients to health care providers who are using health information systems”.

FIGS. 2 through 6 show only the main connections between different parts of the web-site necessary for an understanding of the operation of the web-site. Pages and links that are not essential for the operation of the web-site and those common to the structure of commercial web-sites have been omitted for clarity.
FIG. 2 shows the main links from the “Home Page” 16 of the web-site.
FIG. 3 shows the main pages and links relating to health information technology vendors.
FIG. 4 shows the main pages and links relating to the characteristics of different EMRs.
FIG. 5 shows the main pages and links relating to healthcare providers.
FIG. 6 shows the main pages and links for patients.

Some self-explanatory details on the web-site structure and operation have been omitted to make the drawings less congested.

The web-site is intended to serve several kinds of customers including patients, healthcare providers, health information technology vendors, health insurance companies and employers.

FIG. 2 shows the “Home Page” 16 near the center of the drawing and the main links from there. The text on the “Home Page” 16 of the web-site describes the benefits of choosing a healthcare provider who uses an EMR in terms of improvement of the quality and cost effectiveness of healthcare, and provides pop-ups that give more detailed information and sources of the information. The “Home Page” 16 has links for different customers to enter different areas of the web-site specifically designed for them:
Link for patients—goes to the “Search Page” 28 which allows patients to search for healthcare providers. The search result is not restricted to healthcare providers with EMR's but those who have EMR's appear prominently at the top of the list as well as having their use EMR technology displayed. The pages intended for patients will be described later 29.
Link for healthcare providers—goes to the page “Info for Providers” 23 with general information for providers describing the services the web-site provides and explaining the benefits of advertising on the web-site. Pages intended for healthcare providers will be described later 26. The “Info for Providers” 23 page has a link to the informational pages about the characteristics of different EMR systems 27.
Link for health information technology vendors—goes to the page “Info for Vendors” 22 with general information for vendors describing the services provided and explaining the benefits of advertising on the web-site. Pages for vendors will be described later 25.
Link for health insurance companies—goes to the page “Insurance Companies” 20 with general information describing the services provided and explaining healthcare quality and financial benefits for insurance companies and society as a whole from their participation in making the web-site successful. The “Insurance Companies” 20 page allows the representatives of insurance companies to contact us for more information or with proposals.
Link for employers—goes to the page “Employers” 21 with general information describing services provided and explaining social and financial benefits for employers and society as a whole from their participation in making the web-site successful. The “Employers” 21 page allows representatives of the employers to contact us for more information or with proposals.
Link to the “Non-Patient Login” 24 page which allows registered customers including healthcare providers and health information technology vendors to access their accounts. The pages for registered customers will be described for healthcare providers 26 in FIG. 5 and for vendors 25 in FIG. 3.

The “Home Page” 16 has links to the “User License” 17 agreement page, “Privacy Policy” 18 page and “Contact Us” 19 page which are self-explanatory.

FIG. 3 shows the main structure of the part of the web-site which relates to health information technology vendors. Vendors can get to the “Info for Vendors” 22 page from the “Home Page” 16. The page “Info for Vendors” 22 contains general information for vendors describing services provided by the web-site, explains benefits from advertising on the web-site and provides the opportunity to register with the web-site. In the registration process the vendor provides basic data about his company. This part of the website is common to many commercial web-sites and is not further explained here.

Information about the vendor entered during the registration process is stored in the database “Vendors DB” 30. After successful registration the vendor is directed to the account page “Vendor: Account” 31. The account page “Vendor: Account” 31 contains information on the advertisements placed by this vendor with the web-site. The creation of a user account is not explained further as it is common in many commercial web-sites.

The vendor can also access his account “Vendor: Account” 31 by way of the “Non-Patient Login” 24 link on the “Home Page” 16.

On the account page “Vendor: Account” 31 is a link to the page “Vendor: Company Data” 32 which enables the user to enter and edit general company information and to identify which information can be displayed to the public. The structure and operation of this page is self-explanatory. Data entered or updated on the page “Vendor: Company Data” 32 is stored in the database “Vendors DB” 30.

On the account page “Vendor: Account” 31 is a link to the page “Vendor: Create Ad” 33 which enables the user to place an advertisement for their EMR system (or one each if they make more than one product). The page “Vendor: Create Ad“33 has separate text fields for entering the name of the EMR system, its version identifier and description.

The page “Vendor: Create Ad” 33 informs the vendor that he must provide information on the compatibility and technological abilities of his EMR system in order to place an ad for the EMR. This page also has links to the informational pages “Compat Indx: Info” 35, “Tech Indx: Info” 37 and “Popularity Indx: Info” 39.

The page “Compat Indx: Info” 35 contains information about the nature of the compatibility index and the method used to calculate the index. A link on the page “Compat Indx: Info” 35 takes the vendor to the page “Compat Indx: Test” 36 where the vendor is presented with the list of other registered EMRs. On the page “Compat Indx: Test” 36 the vendor specifies the compatibility of his EMR with the other EMRs on the list by indicating compatibility of incoming and outgoing data. After completion of this task the vendor is returned to the page “Vendor: Create Ad” 33.

In order to calculate the compatibility index the system has to perform several sequential calculations:

1. First, “Product Scores” are calculated for compatibility of this product with each other product in a matrix such that it will not be necessary to recalculate it every time. An example scoring system for the compatibility index is as follows:

| | IMPORT | | EXPORT |
|---|---|---|---|
| | SCORE | | SCORE |
| Importing data to | | Exporting data from | |
| your product from | | your product to the | |
| the index product | | index product | |
| Unknown (default) | 0 | Unknown (default) | 0 |
| No electronic | 0 | No electronic | 0 |
| compatibility | | compatibility | |
| Partial electronic | 1 | Partial electronic | 2 |
| compatibility | | compatibility | |
| Full electronic | 3 | Full electronic | 3 |
| compatibility | | compatibility | |

The Product Score is calculated for each pair of products as the sum of the import and export scores.

The maximum possible Product Score for any pair of products is therefore 6.

2. The “Local compatibility index” is displayed for individual providers only, because “Local” is defined by the ZIP code of the provider. The Local Compatibility Index is calculated once per week for each particular EMR for each ZIP Code registered at the web-site. The results are saved with the data for this EMR in the “EMRs DB” 34.

3. To calculate Local Compatibility Index:
a. For each ZIP code:
   1. find all providers with EMR's in this ZIP code and multiply the number of providers by 6 to calculate the “Ideal Local Compatibility Score”
   2. create list of EMR's used in that ZIP code
   3. For each EMR in that ZIP code find the number of providers using that EMR in that ZIP code
   4. For each EMR (X) used in that ZIP code
      1. set temporary variable “A” to zero
      2. For each EMR (Y) in that ZIP code
         a. Add product of number of providers using that EMR (Y) in that ZIP code by “Product Score” calculated for EMR (X) to temporary variable “A”
      3. Next EMR (Y)
      4. Local Compatibility Index of EMR (X) for this ZIP code=ratio of “A” to “Ideal Local Compatibility Score” expressed as a percentage
   5. Next EMR (X)
b. Loop to next ZIP code

4. The “Global Compatibility Index” is calculated for particular product. It can be recalculated once a week. The result is saved with the data for this EMR in the “EMRs DB” 34.

To calculate the Global Compatibility Index:
a. find all providers with EMR's and multiply the number of providers by 6 to calculate the “Ideal Global Compatibility Score”
b. For each EMR
   i. find the number of providers using that EMR
   ii. Popularity Index=ratio of number of providers using that EMR to number of all providers using EMR's expressed as a percentage. This number is used elsewhere.
c. Next EMR
d. For each EMR (X)
   i. set temporary variable “A” to zero
   ii. For each EMR (Y)
      1. Add product of number of providers using that EMR (Y) by the “Product Score” calculated for EMR (X) to temporary variable “A”
   iii. Next EMR (Y)
   iv. Global Compatibility Index of EMR (X)=ratio of “A” to “Ideal Global Compatibility Score” expressed as a percentage
e. Next EMR (X)

The local compatibility index will not be adversely influenced by providers with multiple ads because each provider is limited to one ad per ZIP code. The global compatibility index will count each ad even if one provider has multiple ads reporting the same or different software.

The page “Tech Indx: Info” 37 contains a description of the criteria used and calculation method for assessing the technological abilities of registered EMRs. From the page “Tech Indx: Info” 37 the vendor can go to the page “Tech Indx: Test” 38 where the vendor is presented with a set of questions about the abilities of his EMR to improve quality and cost effectiveness of healthcare. More detailed information about these questions is presented elsewhere in this patent specification. After completion of this task the vendor is directed back to the page “Vendor: Create Ad” 33.

The technology index shows how the EMR system performs in terms of its ability to make a difference to the care of patients. It is based on the answers to the set questions described elsewhere. While the questions are specific, they are intended to assess classes of checks that are being done by the EMR. Each question is answered with a Yes or No. One point is assigned for every YES answer. The present number of questions is 36. Thus the maximum score is 36. The ratio of the vendor's affirmative answers to the total number of questions is calculated as a percentage. This number is the technology index for this EMR.

The vendor is required to provide the above information on the compatibility and technological abilities of his EMR in order to finish registration of the ad. The page “Popularity Indx: Info” 39 contains information about the nature of the popularity index and the calculation method used for the assessment of the popularity of registered EMRs.

The “Popularity Index” shows the percentage of all the healthcare providers registered with the web-site who use this (major version of) this product. This index shows the popularity of each registered version of this product separately and then the sum of the popularity indices of each of the major versions to give a total popularity index for this product.

The account page “Vendor: Accotnt” 31 also enables the vendor to edit a previously created ad for an EMR by going to the page “Vendor: Edit Ad” 40. The page “Vendor: Edit Ad” 40 has a structure similar to “Vendor: Create Ad” 33 but its fields already contain previously entered information about the EMR. All fields except “Product Name” and “Version identifier” are editable. The product name and version identifier are not editable because they serve as unique identifiers for this EMR. The EMR data is stored in the EMR database “EMRs DB” 34, which is linked to the provider's database “Provider DB” 48 which will be described later. From the page “Vendor: Edit Ad” 40 the vendor can go to the pages “Compat Indx: Test” 36 and “Tech Indx: Test” 38 which were described previously. All fields on the pages “Compat Indx: Test” 36 and “Tech Indx: Test” 38 are already filled in with previously entered information and are editable. In this way the vendor can edit the information about the registered EMR system if necessary. The account page “Vendor: Account” 31 has a Logout 41 function which is self-explanatory. All data about registered EMRs including the calculated indices mentioned above is stored in the database “EMRs DB” 34.

FIG. 4 describes pages that enable various users to see the characteristics of the different EMR systems registered with the web-site. The main customer for this service is healthcare providers who will be interested in the technological capability, compatibility and popularity of the various products. A link from the “Home Page” 16 takes providers to the page “Info for Providers 23” which presents providers with information about the services offered and how to register with the web-site. From this page “Info for Providers” 23, healthcare providers can go to the page “List of EMRs” 42 which will provide them with information about the EMRs registered with the web-site. The page “List of EMRs” 42 consists of a table with the following columns:
Product Name and Major Version Identifier
Manufacturer
Brief Description of the Product.

The list of EMRs comes from the databases “EMRs DB” 34 and “Vendors DB” 30. Optionally global compatibility, technology and/or popularity indices can also be presented in the table for each EMR.

The page “List of EMRs” 42 enables the user to click on the product name he is interested to learn more about and be directed to the page “EMR Ad” 43 with the detailed description of this EMR including all calculated indices and information about its manufacturer if available. The page “EMR Ad” 43 gives links to the pages “Compatibility Index” 44, “Technology Index” 45 and “Popularity Index” 46 with details about how the indices were determined for this particular EMR. The page “Compatibility Index” 44 is a non-editable view of the data in the page “Compat Indx: Test” 36.

The page “Technology Index” 45 is a non-editable view of the data in the page “Tech Indx: Test” 38.

The page “Popularity Index” 46 shows the popularity of this EMR system among healthcare providers and compares it with the popularity of some other registered EMR systems.

The compatibility, technology and popularity indices for this EMR and raw data from which they are calculated come from the database “EMRs DB” 34. Information about the manufacturer is from database “Vendors DB” 30.

Pages with general information about the indices “Compat Indx: Info” 35, “Tech Indx: Info” 37 and “Popularity Indx: Info” 39 optionally can be connected to the pages “List of EMRs” 42, “EMR Ad” 43 or to the pages “Compatibility Index” 44, “Technology Index” 45 and “Popularity Index” 46.

FIG. 5 describes the pages for healthcare providers. From the “Home Page” 16 healthcare providers enter the part of the web-site intended for them, through the link which goes to the page “Info for Providers” 23 which was partly described previously. This page “Info for Providers” 23 presents providers with information about the services offered and how to register with the web-site. From this page “Info for Providers” 23 a healthcare provider can register with the web-site by entering the page “Provider: Register” 47.

In the registration process the healthcare provider provides basic data about himself. This part of the website is common to many commercial web-sites and is not further explained here.

Information about the provider entered during the registration process is stored in the database “Providers DB” 48. After successful registration the provider is directed to the account page “Provider: Account” 49.

The user can also access his account “Provider: Account” 49 from the “Non-Patient Login” 24 page.

From the account page “Provider: Account” 49 the healthcare provider can go to the page Provider: Create Ad 50 where he can create an ad, part of which specifies if he uses an EMR in his practice or not. If the provider uses an EMR then he selects the EMR he is using from the list of EMRs registered with the web-site or enters the name of another EMR if the one he is using is not yet in the list of EMRs in the database “EMRs DB” 34.

Placing a healthcare provider ad on the web-site requires payment for each ad registered. The page “Provider: Create Ad” 50 has a description of the fees and any available discounts or promotions. The user selects a method of payment. The payment information will be displayed on the “Provider: Account” 49 page and is transferred to the checkout system. The checkout system is not further described as it is a common part of most commercial websites.

The account page “Provider: Account” 49 also enables the healthcare provider to edit previously registered ads by directing him to the page “Provider: Edit Ad” 51.

This page “Provider: Edit Ad” 51 is similar to the page “Provider: Create Ad” 50 but it contains all the previously entered data from this ad and this data is editable. Data entered or updated on the pages “Provider: Edit Ad” 51 and “Provider: Create Ad” 50 is stored in the database “Providers DB” 48. The page “Provider: Account” 49 has a link to the “Checkout” 52 pages. The account page “Provider: Account” 49 has a “Logout” 41 function which is self-explanatory.

The main customer on the web-site is the patient. In order to make the service useful to the patient, data must be collected about: health information technology vendors, the EMR systems they produce, the ability of those EMR systems to improve quality and cost effectiveness of healthcare, and the healthcare providers who are using the EMR systems. The web-site offers patients a means to find healthcare providers who can provide better quality healthcare by helping them find the providers who use EMR systems. Because different EMR systems range widely in terms of their compatibility and their ability to improve quality of care, indices are provided (and explained to the patient) to help the patient determine what benefits a given healthcare provider's EMR system offers. The patient can use the web-site to find providers without regard to EMR's, with EMR's and optionally to examine the characteristics of the EMR used by a provider.

FIG. 6 describes the pages for patients. On the “Home Page” 16 patients are educated about the value of choosing a healthcare provider who uses an EMR. The patient can then go to the “Search Page” 28 from which they can search for healthcare providers by entering search criteria.

The “Search Page” 28 has some required and some optional data fields in the form of drop-down lists, options and a text field (for free text search) used by the patient to enter the search criteria. The optional fields enable the patient to narrow his search to more easily find the best match. Then search is performed on the database of registered healthcare providers “Providers DB” 48. The page “Search Results” 53 presents the patient with the matching search results, which are organized as a table with the following columns:
Provider Name
Specialty
Gender
Whether or not provider uses an EMR
ZIP code of the providers office

In this table healthcare providers who use EMR systems appear at the top of the list followed by providers without EMR'S. This alone will preferentially direct patients to providers with EMRs giving them a competitive advantage.

The data columns listed above are meant to be as an example and are perceived to be the minimal necessary for the web-site to operate efficiently. The number and contents of the columns may vary in different implementations in part depending on the data chosen to be collected from the healthcare providers. The essential column is “Whether or not provider uses an EMR”. Columns with the indices characterizing the EMR used by each provider can also be included in the table on the “Search Results” 53 page.

The “Search Results” 53 page enables the patient to see details about a particular provider by clicking on his name. This directs the patient to the page “Provider Ad” 54 with detailed information about this provider and the EMR system he uses.

Data about the healthcare provider and EMR he uses comes from database “Providers DB” 48. Data for the indices characterizing the EMR used by each particular provider comes from the database “EMRs DB” 34.

The page “Provider Ad” 54 has a link which enables the patient to learn more about the EMR system used by this provider. It enables the patient to view the criteria that were used to assess this EMR and detailed results of this assessment by visiting the pages “Compatibility Index” 44, “Technology Index” 45 and “Popularity Index” 46 described above. Pages with general information about these indices “Compat Indx: Info” 35, “Tech Indx: Info” 37 and “Popularity Indx: Info” 39 optionally can be connected to the pages “Search Results” 53, “Provider Ad” 54 or to the pages “Compatibility Index” 44, “Technology Index” 45 and “Popularity Index” 46.

The page “Search Results” 53 allows the patient to refine the search criteria by going back to the “Search Page” 28.

Sometimes the patient will not find what he is looking for. For such cases the page “Search Results” 53 offers to save the patient's search criteria along with their email address for the purpose of automatically repeating the search later at specified intervals and for a specified length of time in order to identify matching healthcare providers who register with the web-site at a later date and to send new positive search results to the patient by email. For this purpose the page “Search Results” 53 sends the patient to the page “Automated Search” 56 where the patient can verify the previously selected search criteria and optionally specify if he would like to limit the search to providers who use EMR'S. These criteria are saved in the database “DB of Search Criteria” 55 which will be used later for the automated search.

Operation of the web-site is impossible without databases storing the information for the web-site. Most of the databases have relations with one another. “Vendors DB” 30 database stores information about the manufacturers of EMRs which is related to the information about these EMRs stored in the “EMRs DB” 37 database. “EMRs DB” 37 database stores detailed information about EMRs registered with the web-site including EMR names, major version identifiers, descriptions, compatibility, technology and popularity indices calculated for these EMRs and details on the compatibility and technology indices in the form of the answers to the questions on tests used for assessment of compatibility and technology indices. “Providers DB” 48 database contains all information about healthcare providers registered with the web-site. Each record about a healthcare provider is linked to the corresponding record about the EMR system he uses in the “EMRs DB” 37 database. The database “DB of Search Criteria” 55 is not directly connected to the other databases serving the web-site.

gg) Description of business model

Numerical labels used below refer to numbers appearing in FIG. 7 on page 7 of the flow sheet drawing. In some places in the drawing the term “Providers” is used instead of “Healthcare Providers” to save space. The website starts with a database containing the vast majority of all healthcare providers in the United States (those with UPIN numbers). Prior to starting operation of the website the EMR field of the record for each healthcare provider is set to “unknown”.

Anticipation of a competitive advantage motivates some providers with EMR's 68 to advertise on the website 65.

Patients 58 are referred 11 by their employers 79 and insurance companies 77 to the website 69. This referral 11 takes place, in the case of employers 79 at the time the employee selects a health insurance plan. The patient 58 usually has to consult an online or printed eligible provider list published by their insurance company 77 in order to select a healthcare provider. Insurance companies 77 use this opportunity to refer 11 the patients 58 to the website 69 because this is the moment when the referral 11 will have the greatest impact on patient 58 behavior.

The website 69 educates patients 58 about the benefits of choosing a healthcare provider with an EMR 68 as opposed to a healthcare provider without an EMR 66.

Patients 58 go to the website 69 and search for a healthcare provider. The search result will include all healthcare providers that meet their search criteria but those healthcare providers with EMR's 68 will be shown first in the search result followed by those providers without EMR's 66 and those healthcare providers for whom EMR status is unknown. The healthcare providers with EMR's 68 will have a competitive advantage just by being listed first and a further competitive advantage because the search report will show that they have an EMR.

Patients 58, having just been educated 62 about the value of EMR systems, will select more providers with EMR's 64 and select fewer providers without EMR's 69 (in proportion to the number of each in the database).

The more providers with EMR's 68 who advertise on the website 65 the more this enhances 61 the tendency for patients 58 to select more providers with EMR's 64.

The more providers with EMR's 68 who advertise on the website 65 the more this enhances 57 the tendency for patients 58 to select fewer providers without EMR's 59.

Because providers without EMR's 66 are at a competitive disadvantage they get more EMR's 67 which increases the fraction of all providers who are providers with EMR's 68. As the fraction of all providers who are providers with EMR's 68 increases it becomes easier for patients 58 to find providers with EMR's 68 which further increases the competitive advantage in favor of providers with EMR's 68.

Because a competitive advantage for providers with EMR's 68 results in providers without EMR's 66 getting more EMR's 67 the vendors of EMR systems 63 gain the advantage of increased sales. Vendors 63 seeing that this system is advantageous to them promote the website 60 to their clients who are the providers with EMR's 68 enhancing 70 the tendency for providers with EMR's 68 to advertise on the website 65.

Providers without EMR's 66 on average provide less cost effective care 75 and providers with EMR's 68 provide more cost effective care 72. Insurance companies 77 and employers 79 anticipate very large financial benefits from both:
1) increasing the fraction of their patients 58 who choose providers with EMR's 68 now and
2) encouraging the providers without EMR's 66 to get EMR's 67.

The website 69 will make employers 79 and insurance companies 77 aware of the potential benefits of this system to them 79 and 77 and to their patients 58. Anticipating these advantages the employers 79 and insurance companies 77 refer their patients 11 to the website 69. The employers 79 and insurance companies 77 will be motivated to encourage providers with EMR's 68 to participate in this system. They have several ways to motivate providers with EMR's:
1) Make all their providers aware of the system through provider newsletters (not in drawing) and make no payments to the providers with EMR's 68.
2) Reimburse providers with EMR's 68 part or all of their cost of advertising on the website 65.
3) Pay providers with EMR's 68 more than their cost of advertising on the website 65 as a form of “pay-for-performance” program. Employers 79 and insurance companies 77 could choose to implement such a reimbursement system taking into account the qualities of the EMR system in use by each provider.

The employers 79 and insurance companies 77 have complete flexibility in deciding how much, if any financial incentive 76 they use to encourage providers with EMR's 68 to advertise on the website 65. They can adjust their approach based on the goals of the individual employer 79 or insurance company 77 as well as the market conditions in that area at any point in time. This is in marked contrast to the “Bridges to Excellence” program which does not adapt to local or temporal variations in conditions. This flexibility in the payment system will be referred to as the flexible payment system 78.

The flexible payment system 78 results in many more employers 79 and insurance companies 77 participating in the system than might participate in other programs.

This amplifies 73 and 74 the effects of their ability to pay providers with EMR's 76 and to refer patients 11.

The flexible payment system 78 also results in all of the employers 79 and insurance companies 77 optimizing the payments (if any) to providers with EMR's 71 based on their own local conditions.

Payments to providers who use EMR's 76 enhances 70 the tendency for providers with EMR's 68 to advertise on the website 65.

Notice that there are several positive feedback loops in this design and that several effects act to amplify others (the triangles in the drawing). The flexibility built into this system enables finely granular optimization of the positive feedback to obtain the desired outcomes.

The result is a system which improves healthcare for patients while at the same time creating a situation in which all stakeholders benefit except providers without EMR's 66.

The same logic that is applied above to healthcare providers with an EMR 68 versus those without an EMR 66 is applied in FIG. 8 on page 8 to providers with advanced EMR's 83 versus those with primitive EMR's 82. The flowchart is the same as that in FIG. 7 except for the following:
1) Providers without EMR's 66 in FIG. 7 is replaced by providers with primitive EMR's 82 in FIG. 8.
2) Providers with EMR's 68 in FIG. 7 is replaced with providers with advanced EMR's 83 in FIG. 8.
3) Select fewer providers without EMR's 59 in FIG. 7 is replaced with Select fewer providers with primitive EMR's 80 in FIG. 8.
4) Select more providers with EMR's 64 in FIG. 7 is replaced with Select more providers with advanced EMR's 81 in FIG. 8 and
5) Can pay providers with EMR's who advertise 76 in FIG. 7 is replaced with can pay providers with advanced EMR's who advertise 84 in FIG. 8.

With these changes the same system now gives providers with advanced EMR's 83 a competitive advantage over providers with primitive EMR'S. The rest of the system works in essentially the same way as that just described for FIG. 7 including the positive feedback and the amplification of one effect by another. The end result is an efficient way to hasten the evolution of EMR systems.

### Additional Embodiment

a) The design of a website is such that this particular website could be implemented in a vast number of different ways without changing the basic functionality of the site.

b) The website could be independent for the sole purpose of providing this service with or without links to and from other medical websites, or it could be hosted on another medical or non-medical website to take advantage of the established traffic on that website.

c) The user could provide search criteria and receive search results through some means other than a website. Options include mail and an automated telephone system.

d) The website can also provide the patient with verification of the credentials of healthcare providers.

### Operation—Additional Embodiment

a) EMR systems can be graded in a pass/fail manner instead of with a graduated score.

b) Details of the performance measures of the EMR systems can be made available only to patients or to healthcare providers or neither.

c) The list of healthcare providers in the database can include only providers with EMR's or only those with EMR's that meet certain criteria instead of all providers regardless of whether they are using an EMR system or the score of that system.

d) When reporting graduated scores of the EMR system in use by an individual provider, the grade may be reported as a single score instead of being broken down for example as a score for compatibility with other EMR systems and another reflecting how advanced the system is in terms of ability to improve patient care and cost effectiveness of care.

e) Reports of compatibility of a provider's EMR can be based on the percentage of other EMR systems which are compatible or the percentage of healthcare providers who are using EMR systems which are compatible. These can be further broken down into compatibility with the EMR systems of providers in the same geographic area (which we chose to implement as our “local compatibility index”) and compatibility with the EMR systems of all providers across the country (which we chose to implement as our “global compatibility index”).

f) Details of the data from which the technology index is derived can be made available to only some of, or none of patients, healthcare providers or EMR vendors.

g) Details of the data from which the compatibility indices are derived can be made available to only some of, or none of patients, healthcare providers or EMR vendors.

h) Random checks of healthcare providers can be made to find and discourage abuse of the system.

i) Checks can be made against the licensed client lists of the producers of EMR systems to find healthcare providers who are posting incorrect information.

j) In the case of access to the data by an automated telephone system the user would call a telephone number, enter location information, enter other search items if desired and perform the search. The result of the search could be given by an electronic voice system or, as in the case of mobile phones, by a message system.

k) Advertising to the general public can be used to a significant degree in addition to or in place of targeting patients at the moment they are choosing a healthcare provider through the health insurance companies and employers.

l) Health insurance companies and/or employers do not need to promote this web service to healthcare providers

m) Health insurance companies and/or employers do not need to use it as part of a “pay-for-performance” program.

n) Removal of the system of flexible payments to healthcare providers by Health Insurance Companies and/or Employers is undesirable but could still be made to operate successfully.

o) Health insurance companies and/or employers can be provided with the names, technology and compatibility indices and the details of the EMR systems used by each registered healthcare provider so that they will have the option to use this data to make, adjust or deny payments to healthcare providers based on the EMR system that healthcare provider is using.

p) Involvement of insurance companies and employers in educating patients and referring them to the website where they can find providers using EMR's could be left out of the implementation although this is less desirable.

q) A utility can be provided which allows a patient to search the database for a provider who is using an EMR system which is compatible with that used by the provider the patient is currently seeing. This could be useful in situations in which a patient is going to see a consultant or changing providers and wants to avoid the dangers and inefficiency that results from EMR systems that are incompatible.

r) The system does not have to obtain compatibility data from EMR system makers but this will prevent reporting compatibility data to providers and patients.

s) When and if a single definite EMR standard is defined then compatibility with that standard can also be reported to patients and healthcare providers.

t) Combining this invention with another system (for example outcomes data from health insurance companies or our invention entitled “Method for reviewing electronic patient medical records to assess and improve the quality and cost effectiveness of medical care” which assesses clinical outcomes measures of individual health information systems) will result in the ability to report to patients objective measures of the quality and cost effectiveness of care provided by each individual healthcare provider.

u) Combining this invention with another system (for example outcomes data from health insurance companies or our invention entitled “Method for reviewing electronic patient medical records to assess and improve the quality and cost effectiveness of medical care” which assesses clinical outcomes measures of individual health information systems) will result in the ability to report to patients and healthcare providers objective measures of the impact on quality and cost effectiveness of care that results from the use of each individual EMR system.

### CONCLUSION, RAMIFICATION AND SCOPE

Conclusion:

EMR systems enhance the quality, safety and cost effectiveness of healthcare.

This is so important that it was the subject of a recent executive order by President Bush. Secretary Thompson of the US Department of Health & Human Services emphasized the importance of moving rapidly on the implementation of EMR's when he stated “we need to move quickly across many fronts to capture these benefits”. This invention provides a solution to the problem of effective education for patients about the value of EMR's by using stakeholders who stand to benefit from making such a system work to refer patients to the service at moment of decision. It also solves the patient's problem of how to find a healthcare provider who is using an EMR as well as the problem of how they can find a provider who is using an EMR system that can most optimally improve their healthcare. By doing these things this invention accelerates both the adoption and the evolution of EMR systems.

Ramification:

This invention has the following unexpected advantages:
(1) Healthcare providers will realize that the system of educating patients about EMR systems and then helping them find a provider who uses this technology will put providers who do not have this technology at a serious disadvantage.
(2) Healthcare providers will realize that providing this education and opportunity to patients temporally proximate to their selection of a healthcare provider will be especially effective at directing patients to those providers who are using an EMR system.
(3) For the above two reasons providers who do not have an EMR system will therefore have an overwhelming incentive to obtain this technology in order to remain competitive.
(4) Even if all healthcare providers are using EMR systems there remains the problem of providers failing to upgrade the technology they are using as EMR systems evolve. This invention will, by using graded reporting of EMR systems (instead of Yes/No reporting) and presenting the results to consumers, maintain a competitive pressure on healthcare providers to keep their EMR systems up to date over time.
(5) The makers of EMR systems which have lesser degrees of compatibility with one another or industry standards or have limited implementation of tools which improve the safety, quality and cost effectiveness of healthcare will be assessed lower scores. This fact will be evident to patients when they are choosing a provider and to healthcare providers when they are choosing an EMR and as result such systems will be less competitive. EMR makers will therefore have more incentive to improve their products in order to remain competitive.
(6) These effects will enhance healthcare for all patients and assist the US Department of Health & Human Services to reach its goal of rapid adoption of EMR systems.
(7) Health insurance companies have an incentive to make this system work because they will benefit from lower cost of healthcare and the marketing value of improved safety and quality of care.
(8) Employers have an incentive to make this system work because they will benefit from lower cost of healthcare and less employee work time lost due to illness.
(9) The makers of EMR systems have an incentive to make this system work because accelerating the adoption of the technology will result in expansion of their market. They will also benefit from the pressure for continued evolution of the technology which will result in more ongoing sales of software upgrades.

Scope:

This invention is intended to cover all implementations which maintain a database of EMR systems, optionally evaluations of those EMR's, a database of healthcare providers and the EMR systems, if any, that they use and a mechanism by which individuals can access this data. It is also specifically meant to include all implementations involving referral temporally proximate to patient selection of a healthcare provider whether that be done through the employer, insurance company or by some other means. It is also specifically meant to include all implementations in which reports to patients include graduated assessments of EMR systems.

It is to be understood that the implementations described in this application are not the only possible implementations and that other options will be apparent to those skilled in the art from consideration of the specification and practice of the invention disclosed herein. It is intended that the specification and examples be considered as exemplary only.

That which is claimed is:

1) A method of improving quality and cost effectiveness of health care comprising:
a) providing a first means for determining which of a plurality of health information technology systems are capable of improving at least one of the measures selected from the group consisting of quality of healthcare, safety of healthcare and cost effectiveness of healthcare,
b) providing a second means for determining which of a plurality of health care providers use said health information technology systems,
c) providing a third means for referring a plurality of patients to said health care providers,
whereby said healthcare providers who are using said health information technology systems obtain a competitive advantage which will accelerate the adoption of said health information technology systems by other said healthcare providers thereby improving the quality, safety and cost effectiveness of the entire healthcare system.

2) A method of improving quality and cost effectiveness of health care of claim 1 wherein said health information technology systems are selected from the group consisting of electronic health record systems, electronic medical record systems, electronic patient health record systems, computerized health record systems, computerized medical record systems, computerized patient record systems, personal health record systems, and health information systems.

3) A method of improving quality and cost effectiveness of health care of claim 1 wherein said measures of quality of healthcare, safety of healthcare and cost effectiveness of healthcare are determined by means selected from the group consisting of
a) objective measures of the clinical performance of said health information technology systems,
b) subjective measures of the clinical performance of said health information technology systems,
c) objective measures of the clinical performance of said plurality of health care providers,
d) subjective measures of the clinical performance of said plurality of health care providers,
e) objective measures of the compatibility of said health information technology systems with other said health information technology systems, and
f) subjective measures of the compatibility of said health information technology systems with other said health information technology systems.

4) A method of improving quality and cost effectiveness of health care of claim 1 wherein said measures of quality of healthcare, safety of healthcare and cost effectiveness of healthcare are reported on a scale selected from the group consisting of a scale with only two possible results and a scale with more than two possible results.

5) A method of improving quality and cost effectiveness of health care of claim 1 wherein said health care providers are selected from the group consisting of physicians, physician's assistants, nurse practitioners, nurses, midwives, hospitals, emergency departments, urgent care clinics, walk-in clinics, podiatrists, optometrists, outpatient surgery clinics, dentists, orthodontists, physical therapists, occupational therapists, speech therapists, speech pathologists, psychologists, chiropractors and otologists.

6) A method of improving quality and cost effectiveness of health care of claim 1 wherein said means for the referral of said patients to said health care providers are selected from the group consisting of education of said patients by health insurance companies and education of the said patients by employers.

7) A method of improving quality and cost effectiveness of health care of claim 1 wherein said means for the referral of said patients to said health care providers comprises transfer of data about eligible providers.

8) A method of improving quality and cost effectiveness of health care comprising:
a) providing a first means for determining which of a plurality of health information technology systems are capable of improving at least one of the measures selected from the group consisting of quality of healthcare, safety of healthcare and cost effectiveness of healthcare,
b) providing a second means for determining which of a plurality of health care providers use said health information technology systems,
c) providing a third means for identifying a plurality of patients at substantially the time when they are searching for a healthcare provider,
d) providing a forth means for referring said plurality of patients to said health care providers who are using said health information technology systems,
whereby patient education and referral at the moment said patients are seeking said healthcare providers significantly increases the probability that said patients will choose said healthcare providers who are using said health information technology systems thereby creating a competitive advantage for said healthcare providers who are using said health information technology systems which in turn will accelerate the adoption of said health information technology systems by other said healthcare providers.

9) A method of improving quality and cost effectiveness of health care of claim 8 wherein said health information technology systems are selected from the group consisting of electronic health record systems, electronic medical record systems, electronic patient health record systems, computerized health record systems, computerized medical record systems, computerized patient record systems, personal health record systems, and health information systems.

10) A method of improving quality and cost effectiveness of health care of claim 8 wherein said measures of quality of healthcare, safety of healthcare and cost effectiveness of healthcare are determined by means selected from the group consisting of
a) objective measures of the clinical performance of said health information technology systems,
b) subjective measures of the clinical performance of said health information technology systems,
c) objective measures of the clinical performance of said plurality of health care providers,
d) subjective measures of the clinical performance of said plurality of health care providers,
e) objective measures of the compatibility of said health information technology systems with other said health information technology systems, and
f) subjective measures of the compatibility of said health information technology systems with other said health information technology systems.

11) A method of improving quality and cost effectiveness of health care of claim 8 wherein said measures of quality of healthcare, safety of healthcare and cost effectiveness of healthcare are reported on a scale selected from the group consisting of a scale with only two possible results and a scale with more than two possible results.

12) A method of improving quality and cost effectiveness of health care of claim 8 wherein said health care providers are selected from the group consisting of physicians, physician's assistants, nurse practitioners, nurses, midwives, hospitals, emergency departments, urgent care clinics, walk-in clinics, podiatrists, optometrists, outpatient surgery clinics, dentists, orthodontists, physical therapists, occupational therapists, speech therapists, speech pathologists, psychologists, chiropractors and otologists.

13) A method of improving quality and cost effectiveness of health care of claim 8 wherein said means for the referral of said patients to said health care providers are selected from the group consisting of education of said patients by health insurance companies and education of the said patients by employers.

14) A method of improving quality and cost effectiveness of health care of claim 8 wherein said means for the referral of said patients to said health care providers comprises transfer of data about eligible providers.

15) A method of improving quality and cost effectiveness of health care comprising:
a) providing a first means for grading a plurality of health information technology systems based on their capability of improving at least one of the measures selected from the group consisting of quality of healthcare, safety of healthcare and cost effectiveness of healthcare,
b) providing a second means for determining which of a plurality of health care providers use said health information technology systems, and
c) providing a third means for referring said plurality of patients to said health care providers
whereby providing said patients with information about the degree to which said health information technology systems used by said healthcare providers enhances patient care will create a competitive advantage for said healthcare providers who have more advanced said health information technology systems which will in turn pressure other said healthcare providers to keep their said health information technology systems up to date in order to remain competitive. Furthermore, whereby competition among the producers of said health information technology systems is enhanced resulting in the acceleration of the evolution of health information technology products and their benefits in terms of said measures of quality of healthcare, safety of healthcare and cost effectiveness of healthcare.

16) A method of improving quality and cost effectiveness of health care of claim 15 wherein said health information technology systems are selected from the group consisting of electronic health record systems, electronic medical record systems, electronic patient health record systems, computerized health record systems, computerized medical record systems, computerized patient record systems, personal health record systems, and health information systems.

17) A method of improving quality and cost effectiveness of health care of claim 15 wherein said measures of quality of healthcare, safety of healthcare and cost effectiveness of healthcare are determined by means selected from the group consisting of
a) objective measures of the clinical performance of said health information technology systems,
b) subjective measures of the clinical performance of said health information technology systems,
c) objective measures of the clinical performance of said plurality of health care providers,
d) subjective measures of the clinical performance of said plurality of health care providers,
e) objective measures of the compatibility of said health information technology systems with other said health information technology systems, and
f) subjective measures of the compatibility of said health information technology systems with other said health information technology systems.

18) A method of improving quality and cost effectiveness of health care of claim 15 wherein said health care providers are selected from the group consisting of physicians, physician's assistants, nurse practitioners, nurses, midwives, hospitals, emergency departments, urgent care clinics, walk-in clinics, podiatrists, optometrists, outpatient surgery clinics, dentists, orthodontists, physical therapists, occupational therapists, speech therapists, speech pathologists, psychologists, chiropractors and otologists.

19) A method of improving quality and cost effectiveness of health care of claim 15 wherein said means for the referral of said patients to said health care providers are selected from the group consisting of education of said patients by health insurance companies and education of the said patients by employers.

20) A method of improving quality and cost effectiveness of health care of claim 15 wherein said means for the referral of said patients to said health care providers comprises transfer of health insurance plan eligibility data about said healthcare providers.

21) A method of improving quality and cost effectiveness of health care by means of a service comprising:
a) maintaining a database containing data related to a plurality of EMR systems and containing data related to a plurality of healthcare providers including which one of said EMR systems is used by each said healthcare provider, said database accessible to a central host which is connected to the Internet,
b) optionally accepting a plurality of referrals of a plurality of patients from at least one of the group consisting of a plurality of health insurance companies and a plurality of employers for the purpose of assisting said patients to find said healthcare providers who are using any of said EMR systems,
c) providing a means by which said patients can search said database via said Internet,
d) assisting said patients to find said healthcare providers who are using any of said EMR systems,
e) providing advertising for said healthcare providers optionally in return for a predetermined fee, said advertising to include data describing at least said EMR system used by each said healthcare provider,
f) providing said service to said health insurance companies at substantially no cost,
g) providing said service to said employers at substantially no cost,
h) optionally providing at least one of the group consisting of
i) said health insurance companies and
ii) said employers
the opportunity to make at least one payment of a predetermined amount to said healthcare providers,
said payment being selected from the group consisting of
(1) reimbursement of said payment made by said healthcare provider,
(2) payment on behalf of said healthcare provider,
(3) adjustment of fees paid by said health insurance companies to said healthcare providers,
said payment being for the purpose selected from the group consisting of
(1) encouraging said healthcare providers who are using said EMR systems to advertise with said service and
(2) rewarding said healthcare providers for the use of said EMR systems,
whereby said healthcare providers who are using said EMR systems obtain a competitive advantage in terms of improved access to said patients which will accelerate the adoption of said EMR systems by other said healthcare providers thereby improving the quality, safety and cost effectiveness of the entire healthcare system.
SEQUENCE LISTING
Not applicable
